(19) United States
(12) Patent Application Publication
(10) Pub. No.: US 2013/0048701 A1
(43) Pub. Date: Feb. 28, 2013

(54) METHODS OF FORMING WEAR RESISTANT LAYERS ON METALLIC SURFACES

(71) Applicants: Prakash K. Mirchandani, Houston, TX (US); Morris E. Chandler, Santa Fe, TX (US)

(72) Inventors: Prakash K. Mirchandani, Houston, TX (US); Morris E. Chandler, Santa Fe, TX (US)

(21) Appl. No.: 13/222,324

(22) Filed: Aug. 31, 2011

(51) Int. Cl. B23K 31/02

(52) U.S. Cl. 228/121

(57) ABSTRACT

Methods for forming a wear resistant layer metallurgically bonded to at least a portion of a surface of a metallic substrate may generally comprise positioning hard particles adjacent the surface of the metallic substrate, and infiltrating the hard particles with a metallic binder material to form a wear resistant layer metallurgically bonded to the surface. In certain embodiments of the method, the infiltration temperature may be 50° C. to 100° C. greater than a liquidus temperature of the metallic binder material. The wear resistant layer may be formed on, for example, an exterior surface and/or an interior surface of the metallic substrate. Related wear resistant layers and articles of manufacture are also described.

### BACKGROUND OF THE TECHNOLOGY

1. Field of Technology

This application generally relates to methods for forming wear resistant layers on surfaces of metallic articles of manufacture (i.e., substrates). The wear resistant layers may provide resistance to wear caused by abrasion, impact, erosion, corrosion, and/or heat.

2. Description of the Background of the Technology

Wear resistant materials may be applied as coatings to protect metallic substrates from degradation due to mechanical, chemical, and/or environmental conditions. For example, methods of coating or hardfacing metallic substrates may involve applying a hard, wear resistant material to a surface of the metallic substrate to reduce wear caused by abrasion, impact, erosion, corrosion, and/or heat. A variety of conventional methods may be utilized to apply wear resistant material to the surface of metallic substrates. In hardfacing, for example, a wear resistant layer may be welded onto the surface of a metallic substrate. In another method, a wear resistant layer is applied to the surface of the metallic substrate using a viscous paste, usually in the form of a flexible sheet or cloth, at an elevated temperature. Conventional wear resistant materials are commercially available from, for example, Kennametal Inc. (under the trade name CONFORMA CLAD), Innobraze GmbH (under the trade name BRAZECOAT), and Gremada Industries (under the trade name LASERCARB). The wear resistant materials may be applied to articles subjected to wear such as, for example, extruders, containers, gear boxes, bearings, compressors, pumps, pipes, tubing, molding dies, valves, reactor vessels, and components of mining and earth moving equipment.

Conventional methods for applying wear resistant material to surfaces of metallic substrates may suffer from one or more of the following limitations: conventional wear resistant materials may be difficult to apply to the internal surfaces and geometrically complex surfaces of certain metallic substrates using conventional application methods; conventional methods may limit the thickness and coverage area of the wear resistant layer; the possible composition of wear resistant materials may be limited because many conventional application methods require complete melting of the materials during application; and conventional application methods may be time consuming and expensive.

Therefore, it would be advantageous to provide improved methods for applying wear resistant materials to surfaces of metallic substrates.

### SUMMARY

One non-limiting aspect according to the present disclosure is directed to a method of forming a wear resistant layer on a metallic substrate. The method may generally comprise positioning hard particles adjacent at least a region of a surface of the metallic substrate and infiltrating the hard particles with a metallic binder material to form the wear resistant layer metallurgically bonded to the surface of the metallic substrate. In certain non-limiting embodiments of the method, the infiltration temperature may be 50° C. to 100° C. greater than a liquidus temperature of the metallic binder material. In certain non-limiting embodiments of the method, the time of infiltration may be less than one (1) hour. In certain non-limiting embodiments of the method, the wear resistant layer may be formed on an exterior surface and/or an interior surface of the metallic substrate. In certain non-limiting embodiments of the method, the wear resistant layer may have a thickness from 1 mm to 100 mm. The wear resistant layer is not be formed by either of welding or hardfacing.

Another non-limiting aspect according to the present disclosure is directed to a wear resistant layer comprising hard particles infiltrated with a metallic binder material and metallurgically bonded to at least a region of a surface of a metallic substrate. In certain non-limiting embodiments, the metallic substrate may comprise one of a steel, nickel, a nickel alloy, titanium, a titanium alloy, aluminum, an aluminum alloy, copper, a copper alloy, cobalt, a cobalt alloy, and combinations thereof. In certain non-limiting embodiments, the metallic binder material may comprise at least one of copper, a copper alloy, aluminum, an aluminum alloy, iron, an iron alloy, nickel, a nickel alloy, cobalt, a cobalt alloy, titanium, a titanium alloy, magnesium, a magnesium alloy, a bronze, and a brass. In certain non-limiting embodiments, the hard particles may comprise at least one of carbide particles, nitride particles, boride particles, silicide particles, oxide particles, and particles comprising a solid solution of at least two of carbide, nitride, boride, silicide, and oxide. In certain non-limiting embodiments, the hard particles have a solidus temperature at least 50° C. greater than a liquidus temperature of the metallic binder material. In certain non-limiting embodiments, the wear resistant layer may comprise 10 to 90 volume percent of the hard particles.

A further non-limiting aspect according to the present disclosure is directed to an article of manufacture comprising a wear resistant layer according to the present disclosure disposed on at least a region of a surface of the article. In certain non-limiting embodiments, the article of manufacture may be one of a pipe, a tube, a valve, a valve part, a flange, a bearing, a drill bit, an earth boring bit, a die, a container, a part or a component used in earth moving equipment, or a radial bearing for mud motors used in oil/gas exploration. One particular non-limiting embodiment of an article of manufacture according to the present disclosure is a pipe for conducting abrasive and/or corrosive fluids, wherein a wear resistant layer according to the present disclosure is disposed on at least a region of an interior surface of the pipe that is contacted by the fluids being conducted through the pipe.

An additional non-limiting aspect according to the present disclosure is directed to a method of improving the resistance of at least a region of a metallic surface to at least one of abrasion, impact, erosion, corrosion, and heat by providing a wear resistant layer according to the present disclosure on the region of the metallic surface.

It is understood that the invention disclosed and described in this specification is not limited to the embodiments described in this Summary.

### BRIEF DESCRIPTION OF THE DRAWINGS

The various non-limiting embodiments described herein may be better understood by considering the following description in conjunction with one or more of the accompanying drawings.

FIG. 1 is a flowchart illustrating a non-limiting embodiment of a method of forming a wear resistant layer according to the present disclosure.

FIG. 2 is a cross-sectional view illustrating aspects of a non-limiting embodiment of a method of forming a wear resistant layer according to the present disclosure.

FIGS. 3A and 3B are cross-sectional views illustrating aspects of non-limiting embodiments of methods of forming wear resistant layers according to the present disclosure.

FIG. 4 is a cross-sectional view illustrating aspects of non-limiting embodiments of methods of forming a wear resistant layer according to the present disclosure.

FIGS. 5-8 are photographs illustrating non-limiting embodiments of stainless steel tubes comprising a wear resistant layer on an interior surface according to the present disclosure.

FIG. 9 is a photomicrograph illustrating a non-limiting embodiment of a stainless steel tube according to the present disclosure having a wear resistant layer on the interior surface thereof comprising cast carbide (WC+W₂C) particles infiltrated by a bronze alloy (by weight, 78% copper, 10% nickel, 6% manganese, and 6% tin).

FIG. 10 is a photomicrograph illustrating a non-limiting embodiment of a stainless steel tube according to the present disclosure comprising a wear resistant layer on the interior surface thereof comprising silicon carbide particles infiltrated by a bronze alloy (by weight, 78% copper, 10% nickel; 6% manganese, and 6% tin).

FIG. 11 is a photomicrograph illustrating a non-limiting embodiment of a stainless steel tube according to the present disclosure comprising a wear resistant layer on the interior surface thereof comprising cast carbide (WC+W₂C) particles infiltrated by a brass alloy (by weight, 53% copper, 15% nickel, 24% manganese, and 8% zinc).

FIG. 12 is a photomicrograph illustrating a non-limiting embodiment of a stainless steel tube according to the present disclosure comprising a wear resistant layer on the interior surface thereof comprising tungsten carbide particles infiltrated by a brass (by weight, 53% copper, 15% nickel, 24% manganese, and 8% zinc).

The reader will appreciate the foregoing details, as well as others, upon considering the following description of various non-limiting and non-exhaustive embodiments according to the present disclosure.

### DESCRIPTION

The present disclosure describes features, aspects, and advantages of various embodiments of methods for forming wear resistant layers. It is understood, however, that this disclosure also embraces numerous alternative embodiments that may be accomplished by combining any of the various features, aspects, and/or advantages of the various embodiments described herein in any combination or sub-combination that one of ordinary skill in the art may find useful. Such combinations or sub-combinations are intended to be included within the scope of this specification. As such, the claims may be amended to recite any features or aspects expressly or inherently described in, or otherwise expressly or inherently supported by, the present disclosure. Further, Applicants reserve the right to amend the claims to affirmatively disclaim any features or aspects that may be present in the prior art. Therefore, any such amendments comply with the requirements of 35 U.S.C. §112, first paragraph, and 35 U.S.C. §132(a). The various embodiments disclosed and described in this specification may comprise, consist of, or consist essentially of the features and aspects as variously described herein.

All numerical quantities stated herein are approximate, unless stated otherwise. Accordingly, the term “about” may be inferred when not expressly stated. The numerical quantities disclosed herein are to be understood as not being strictly limited to the exact numerical values recited. Instead, unless stated otherwise, each numerical value included in the present disclosure is intended to mean both the recited value and a functionally equivalent range surrounding that value. Notwithstanding the approximations of numerical quantities stated herein, the numerical quantities described in specific examples of actual measured values are reported as precisely as possible.

All numerical ranges stated herein include all sub-ranges subsumed therein. For example, a range of “1 to 10” is intended to include all sub-ranges between and including the recited minimum value of 1 and the recited maximum value of 10. Any maximum numerical limitation recited herein is intended to include all lower numerical limitations. Any minimum numerical limitation recited herein is intended to include all higher numerical limitations.

In the following description, certain details are set forth in order to provide a better understanding of various embodiments. However, one skilled in the art will understand that these embodiments may be practiced without these details. In other instances, well-known structures, methods, and/or techniques associated with methods of practicing the various embodiments may not be shown or described in detail to avoid unnecessarily obscuring descriptions of other details of the various embodiments.

As generally used herein, the articles “the”, “a”, and “an” refer to one or more of what is claimed or described.

As generally used herein, the terms “include”, “includes”, and “including” are meant to be non-limiting.

As generally used herein, the terms “have”, “has”, and “having” are meant to be non-limiting.

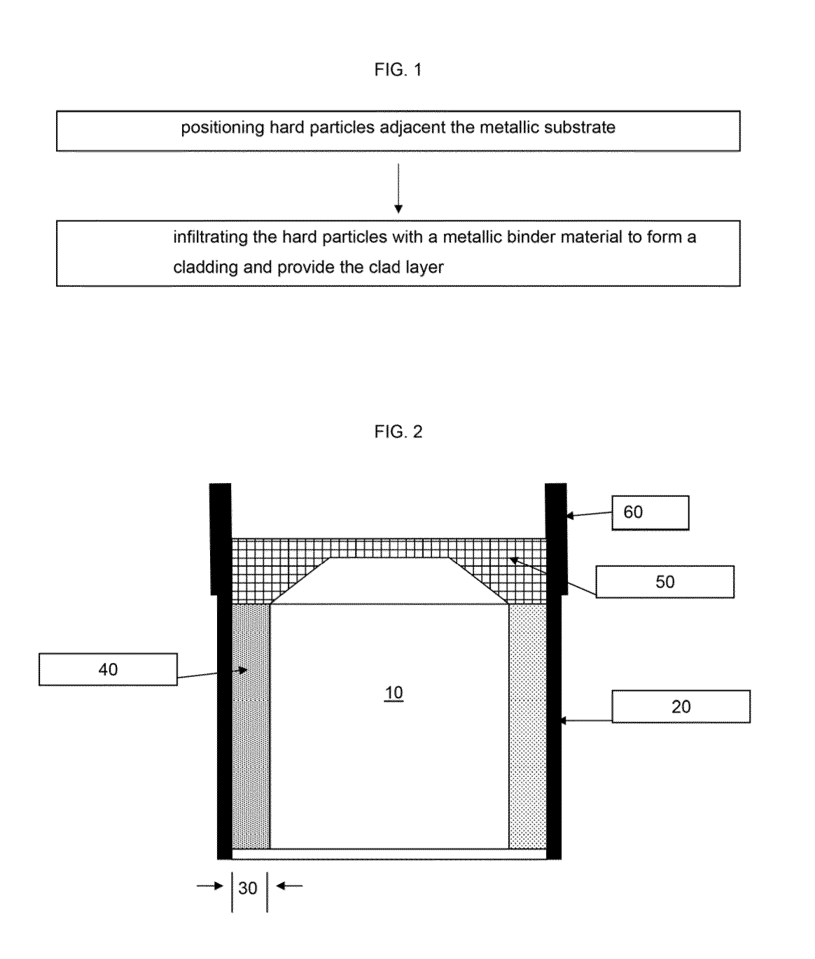

Referring to FIG. 1, in various non-limiting embodiments according to the present disclosure, a method for forming a wear resistant layer on at least a region of a surface of a metallic substrate generally comprises positioning hard particles adjacent the surface of the metallic substrate and infiltrating the hard particles with a metallic binder material to form a wear resistant layer metallurgically bonded to the surface of the metallic substrate. The wear resistant layer may protect all or a region of the surface of the metallic substrate from wear caused by one or more of abrasion, impact, erosion, corrosion, and heat. In various embodiments, a method of improving the resistance of a metallic surface to at least one of abrasion, impact, erosion, corrosion, and heat may generally comprise providing the wear resistant layer on at least a region of a surface of the metallic substrate.

Certain embodiments of methods of providing wear resistant layers described herein may have advantages over conventional approaches. Such advantages may include, but are not limited to, the ability to provide wear resistant layers: on internal surfaces and surfaces having complex geometries; having greater thicknesses and covering larger areas; not limited by the topography of the metallic substrate; having a wide range of compositions; and/or by application methods that are faster and/or less expensive. The present methods utilize infiltration to provide the wear resistant layers and, thus, differ fundamentally from methods utilizing welding and/or hardfacing application techniques.

The metallic substrate and, consequently, the surface on which the wear resistant layer is provided may be, for example, a metal or a metal alloy. In certain non-limiting embodiments, the metallic substrate may comprise one of cast iron, a steel (for example, a carbon steel or a stainless steel), nickel, a nickel alloy, titanium, a titanium alloy, aluminum, an aluminum alloy, copper, a copper alloy, cobalt, a cobalt alloy, and alloys including combinations thereof. In certain non-limiting embodiments, the metallic substrate may be a portion or region of an article of manufacture, such as, for example, an extruder, a gear box, a compressor, a pump, a reactor vessel, a container, a pipe, a tube, a valve, a valve part, a flange, a bearing, a drill bit, an earth boring bit, a mold, a die, a part or component of mining or earth moving equipment, or a radial bearing for mud motors used in oil/gas exploration. In at least one non-limiting embodiment, the article of manufacture may comprise a pipe for conducting abrasive or corrosive fluids or other materials, and the wear resistant layer according to the present disclosure may be disposed on at least a region of an interior surface of the pipe that is contacted by the fluids or other materials being transported through the pipe. The materials and fluids may be, for example, and without limitation: hot caustic materials; slag or coke particles; liquids in oil producing facilities; tar sands; or oil sands.

In various non-limiting embodiments, the hard particles may comprise at least 10 volume percent of the wear resistant layer, such as, for example, at least 25 volume percent, at least 50 volume percent, at least 75 volume percent, at least 80 volume percent, at least 85 volume percent, 10 to 90 volume percent, 25 to 75 volume percent, or 25 to 70 volume percent. In certain non-limiting embodiments, the hard particles may comprise at least one of carbide particles, nitride particles, boride particles, silicide particles, oxide particles, and particles comprising a solid solution of at least two of carbide, nitride, boride, silicide, and oxide. In certain non-limiting embodiments, the hard particles may comprise carbide particles of at least one transition metal selected from titanium, chromium, vanadium, zirconium, hafnium, tantalum, molybdenum, niobium, and tungsten.

In various non-limiting embodiments of a method according to the present disclosure, the hard particles may comprise sintered cemented carbide particles. The sintered cemented carbide particles may comprise, for example, particles including at least one carbide of a metal selected from Groups IVB, VB, and VIB of the Periodic Table dispersed in a continuous binder comprising at least one of cobalt, a cobalt alloy, nickel, a nickel alloy, iron, and an iron alloy. In certain non-limiting embodiments, the sintered cemented carbide particles may comprise particles including 60 to 98 weight percent of at least one carbide of a metal selected from Groups IVB, VB, and VIB of the Periodic Table, and 2 to 40 weight percent of a continuous binder. The continuous binder optionally may comprise at least one additive selected from tungsten, chromium, titanium, vanadium, niobium, and carbon in a concentration at any level up to the solubility limit of the additive in the continuous binder. The continuous binder of the sintered cemented carbide particles also my optionally comprise at least one additive selected from silicon, boron, aluminum, copper, ruthenium, and manganese.

In various non-limiting embodiments, the hard particles may comprise at least one of a metal powder and a metal alloy powder. In at least one non-limiting embodiment, the hard particles may comprise a cast tungsten carbide powder. In another non-limiting embodiment, the hard particles may comprise a monocrystalline tungsten carbide powder. In yet another non-limiting embodiment, the hard particles may comprise a silicon carbide powder. In certain non-limiting embodiments of the method, the hard particles have an average particle size of 0.1 to 200 micrometers, such as, for example, 1 to 200 micrometers, 0.3 to 8 micrometers, 0.3 to 10 micrometers, 0.5 to 10 micrometers, 1 to 10 micrometers, 5 to 50 micrometers, 10 to 100 micrometers, or 10 to 150 micrometers. However, it will be understood that the hard particles may have any average particle size suitable for providing a wear resistant layer produced by the method of the present disclosure.

The metallic binder material used in the method of the present disclosure may comprise, for example, at least one of copper, a copper alloy, aluminum, an aluminum alloy, iron, an iron alloy, nickel, a nickel alloy, cobalt, a cobalt alloy, titanium, a titanium alloy, magnesium, a magnesium alloy, a bronze, and a brass. In at least one non-limiting embodiment, the metallic binder material comprises a bronze consisting essentially of 78 weight percent copper, 10 weight percent nickel, 6 weight percent manganese, 6 weight percent tin, and incidental impurities. In another non-limiting embodiment, the metallic binder material comprises a bronze consisting essentially of 53 weight percent copper, 24 weight percent manganese, 15 weight percent nickel, 8 weight percent zinc, and incidental impurities. The metallic binder material optionally further comprises at least one melting point reducing constituent selected from the group consisting of boron, a boride, silicon, a silicide, chromium, and manganese. In certain embodiments, the binder materials are selected from copper-based alloys, nickel-based alloys, and cobalt-based alloys and include at least one melting point reducing constituent selected from boron, silicon, and chromium.

In various non-limiting embodiments, the wear resistant layer may be formed on an interior surface of the metallic substrate. Referring to FIG. 2, a non-limiting embodiment of a method for forming a wear resistant layer metallurgically bonded to an interior surface of metallic substrate may generally comprise: positioning a mandrel 10 proximate to a surface of a metallic substrate 20 to define a gap 30 between the mandrel 10 and the surface of the metallic substrate 20; positioning hard particles 40 adjacent the surface of the metallic substrate 20; and infiltrating the hard particles 40 with a metallic binder material 50 to form a wear resistant layer metallurgically bonded to the surface. The metallic substrate 20, hard particles 40, and metallic binder material 50 may comprise, for example, any combination of the various metallic substrates, hard particles, and metallic binder materials described herein. The method may comprise positioning a homogeneous layer of the hard particles 40 in the gap 30. The method may further comprise positioning a homogeneous layer of the metallic binder material 50 adjacent the homogeneous layer of the hard particles 40 and adjacent the mandrel 10. Alternatively, the method may comprise positioning a heterogeneous layer of the hard particles 40 and the metallic binder material 50 adjacent the mandrel 10.

In various non-limiting embodiments, the method may comprise positioning a funnel 60 adjacent to a surface of the metallic substrate 20. The funnel 60 may be configured to receive the hard particles 40 and/or metallic binder material 50. The funnel 60 may be configured to receive a homogeneous layer of the metallic binder material 50. The method may comprise positioning a homogeneous layer of the hard particles 40 in the gap 30 between the mandrel 10 and the metallic substrate 20 and positioning a homogeneous layer of the metallic binder material 50 in the gap 30 between the mandrel 10 and the funnel 60. In various embodiments, the method may comprise, after infiltrating the metallic substrate with the metallic binder material, separating the funnel 60 and the metallic substrate 20.

The gap 30 may be any suitable dimension to provide a wear resistant layer of a desired thickness. In various non-limiting embodiments, the gap may be of a constant dimension. In certain embodiments, the gap may be 1 mm to 250 mm, such as, for example, less than 40 mm, less than 25 mm, 1 mm to 100 mm, 1 mm to 50 mm, 1 mm to 20 mm, 1 mm to 10 mm, 3 mm to 10 mm, or 3 mm to 8 mm. In various non-limiting embodiments, the gap may be of a variable dimension. For example, the gap may have a first dimension at a first region of the mandrel and different dimensions at one or more other regions of the mandrel. In certain embodiments, the gap may have a first dimension between the mandrel and the metallic substrate, and the gap may have a second dimension between the mandrel and the funnel. As shown in FIG. 2, for example, the width of the gap may be constant between the mandrel and metallic substrate, and the width of the gap may be variable between the funnel and the metallic substrate.

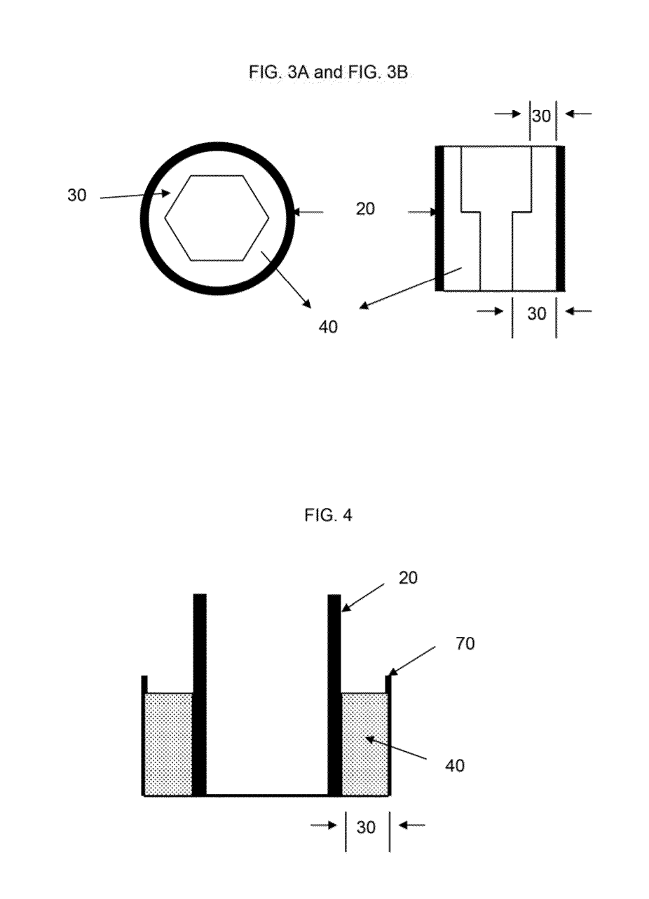

The mandrel may have any constant or variable cross-sectional shape necessary to provide a gap suitably configured to result in a wear resistant layer of a desired thickness and contour. The cross-sectional shape of the mandrel may comprise, for example, a circle, an annulus, an ellipse, an oval, a polygon, a parallelogram, a rectangle, a square, a trapezoid, a triangle, and any combination thereof. As shown in FIG. 2, in at least one embodiment, the mandrel may have a trapezoidal cross-sectional shape. As shown in FIG. 3A, in at least one embodiment, the mandrel may have a hexagonal cross-sectional shape. As shown in FIG. 3B, in at least one embodiment, the mandrel may have a cross-sectional shape that is an irregular polygon (a step profile). In various embodiments, the mandrel may comprise a graphite plug. In certain other embodiments, the mandrel may be of any suitable shape and dimensions and comprises any suitable metallic alloy having a solidus temperature at least 100° C. higher than the infiltration temperature used in the method. In yet other embodiments, the mandrel comprises a ceramic material (such as, for example, aluminum oxide, silicon carbide, or boron nitride) having a solidus temperature at least 100° C. higher than the infiltration temperature used in the method. As noted, the cross-sectional shape of the mandrel may be different in different positions on the mandrel so as to provide a suitably configured wear resistant layer.

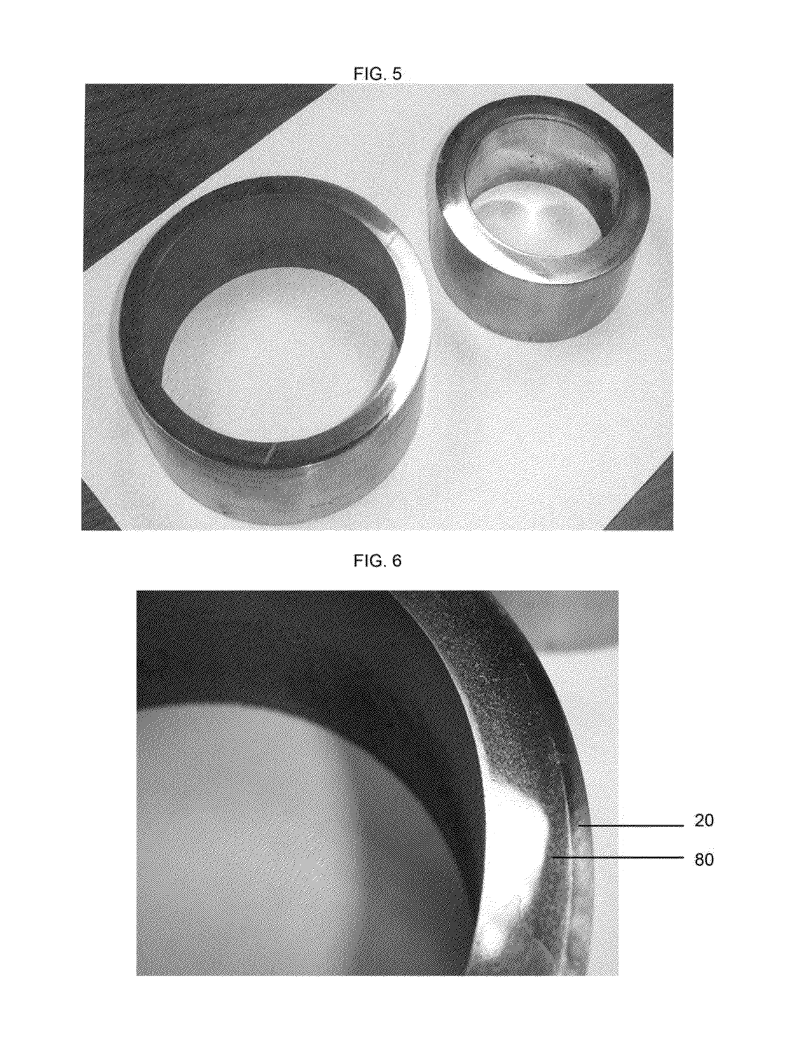

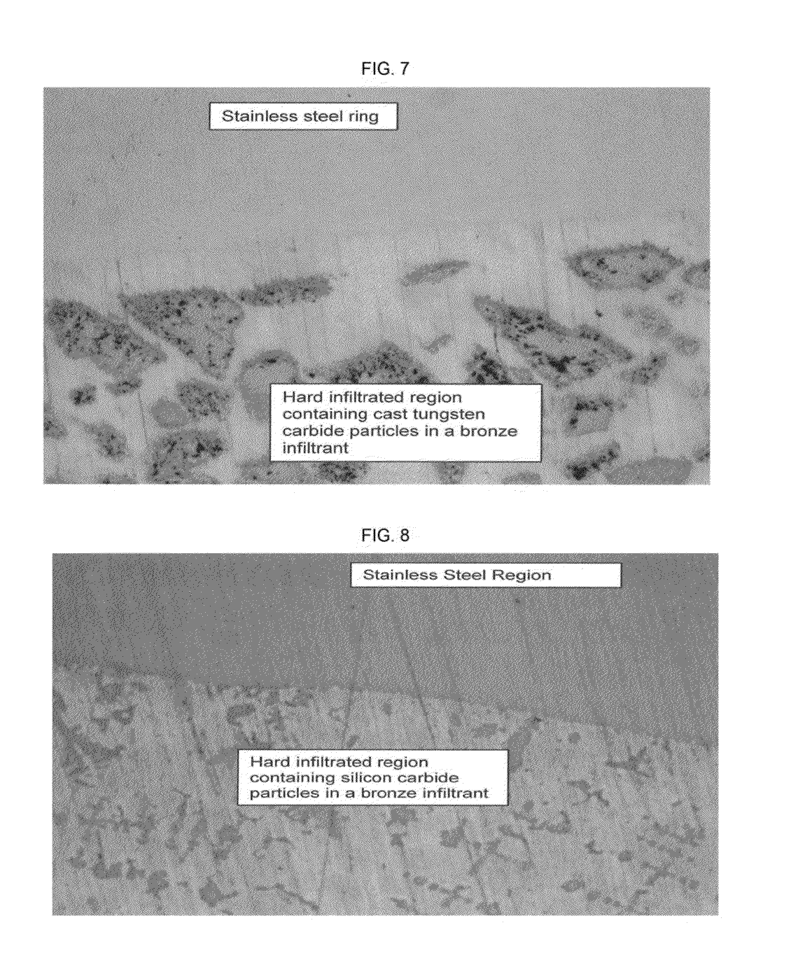

In various non-limiting embodiments, a cross-sectional shape of the wear resistant layer may be the same as or different than the cross-sectional shape of the metallic substrate. As described above, the thickness of the wear resistant layer may be related to the cross-sectional shape of the mandrel and the gap. In various embodiments, the cross-sectional shape of the mandrel and the gap at various points may be configured to provide a wear resistant layer having a cross-sectional shape that is a shape selected from, for example, a circle, an ellipse, an oval, a polygon, a parallelogram, a rectangle, a square, a trapezoid, and a triangle. As shown in FIGS. 5 and 6, in various non-limiting embodiments the cross-sectional shape of the wear resistant layer may be the same as a cross-sectional shape of the metallic substrate. In FIGS. 5 and 6, the wear resistant layer has a circular cross-sectional shape, and the metallic substrate also has a circular cross-sectional shape. As shown in FIGS. 3A and 3B, in other non-limiting embodiments, the cross-sectional shape of the wear resistant layer may be different than the cross-sectional shape of the metallic substrate. In the portion of FIG. 3A showing the transverse cross-section (left portion), the wear resistant layer has a hexagonal internal cross-sectional shape, and the metallic substrate has a circular cross-sectional shape. In the portion of FIG. 3A showing the longitudinal cross-section (right portion), the wear resistant layer has an irregular polygonal (a step profile) cross-sectional shape, and the metallic substrate has a rectangular cross-sectional shape.

In various embodiments, the contour of the wear resistant layer may or may not be identical to the contour of the surface being coated. As described above, conventional methods of applying wear resistant materials are line-of-sight methods in which the contour of the wear resistant material is generally the same as the contour of the surface being coated. In contrast, in various non-limiting embodiments of the method of the present disclosure, the contour of the one or more wear resistant layers may be different than the contour of the surface being coated. As shown in the transverse cross-section of FIG. 3A, for example, the contour of the wear resistant layer may be hexagonal, and the contour of the metallic substrate may be circular. As shown in the longitudinal cross-section of FIG. 3A, the contour of the wear resistant layer may be an irregular polygon (a step profile), and the contour of the metallic substrate may be rectangular. In various non-limiting embodiments, the present method may comprise providing a mandrel having a suitable cross-sectional shape and/or contour to provide a wear resistant layer having a desired contour. For example, the mandrel may provide a wear resistant layer having a screw thread contour to the interior surface of a metallic substrate having a circular contour.

In various embodiments, thickness of the wear resistant layer may be less than, equal to, or greater than the thickness of the metallic substrate. In certain non-limiting embodiments, the thickness of the wear resistant layer may be, for example, 1 mm to 250 mm, such as, for example, less than 40 mm, less than 25 mm, 1 mm to 100 mm, 1 mm to 50 mm, 1 mm to 20 mm, 1 mm to 10 mm, or 0.3 mm to 10 mm. In at least one embodiment, the thickness of the wear resistant layer may be greater than 100 mm. In at least one embodiment, the thickness of the wear resistant layer may be greater than 25 mm. As shown in FIG. 6, in various embodiments, the thickness of the wear resistant layer 80 may be greater than the thickness of the metallic substrate 20.

In various non-limiting embodiments, the wear resistant layer may be formed on an exterior surface of the metallic substrate. Referring to FIG. 4, a non-limiting embodiment of a method for forming a wear resistant layer metallurgically bonded to an exterior surface of a metallic substrate may generally comprise disposing the metallic substrate 20 in a mold 70 to define a gap 30 between the mold 70 and the exterior surface of the metallic substrate 20, positionirig hard particles 40 adjacent the exterior surface of the metallic substrate 20 in the mold 70, and infiltrating the hard particles 40 with a metallic binder material (not shown) to form a wear resistant layer metallurgically bonded to the exterior surface. The method may comprise positioning a homogeneous layer of the hard particles 40 in the gap 30. The method may further comprise positioning a homogeneous layer of the metallic binder material adjacent the homogeneous layer of the hard particles 40 in the mold 70. In various embodiments, the method may further comprise positioning a funnel 60 adjacent to the metallic substrate 20. As described above, the funnel 60 may be configured to receive the hard particles 40 and/or the metallic binder material. The method may comprise positioning at least a portion of the homogeneous layer of the metallic binder material in the funnel 60.

In various non-limiting embodiments, as described above, the gap may be any suitable dimension to provide a wear resistant layer of a desired thickness. The gap may have a constant dimension or variable dimensions. In certain non-limiting embodiments, the gap between the mandrel and the surface of the metallic substrate may be 1 mm to 250 mm, such as, for example, less than 40 mm, less than 25 mm, 1 mm to 100 mm, 1 mm to 50 mm, 1 mm to 20 mm, and 1 mm to 10 mm. When the article and mandrel are positioned in a mold, for example, the gap may comprise a first dimension at a first region of the mold and different dimensions at one or more other regions of the mold. In certain embodiments in which a funnel is utilized, the gap may comprise a first dimension between the mold and the metallic substrate and a second dimension between the metallic substrate and the funnel.

In various non-limiting embodiments of the method according to the present disclosure, a cross-sectional shape and dimensions of the mold may comprise any suitable shape and dimensions to provide a gap suitable to form a wear resistant layer of a desired shape and thickness. The cross-sectional dimension of the mold may be any combination of the mandrel's cross-sectional dimensions and contours described above. The cross-sectional shape of the mold may comprise, for example, a circle, an annulus, an ellipse, an oval, a polygon, a parallelogram, a rectangle, a square, a trapezoid, a triangle, and any combination thereof. As shown in FIG. 4, in at least one embodiment, the mold may be a rectangle. In various embodiments, the mold may comprise a graphite mold. In certain embodiments, the mold comprises any suitable metallic alloy having a solidus temperature at least 100° C. higher than the infiltration temperature used in the method. In yet other embodiments, the mold comprises a ceramic material (such as, for example, aluminum oxide, silicon carbide, or boron nitride) having a solidus temperature at least 100° C. higher than the infiltration temperature used in the method. More generally, the mold may comprise any suitable material that may be included in a mandrel used in certain embodiments of the method of the present disclosure.

In various embodiments, a cross-sectional shape of the wear resistant layer may be the same as or different than the cross-sectional shape of the metallic substrate. The thickness of the wear resistant layer may be related to the cross-sectional shape of the mold and the gap between the mold and the metallic substrate. In various non-limiting embodiments, a cross-sectional shape of the mold and the gap may be configured to provide a wear resistant layer having, for example, any of the cross-sectional shapes and contours described herein, such as, for example, a circle, an ellipse, an oval, a polygon, a parallelogram, a rectangle, a square, a trapezoid, and a triangle. Also as noted, in various embodiments the contour of the wear resistant layer may or may not be identical to the contour of the surface being coated. Non-limiting embodiments of the present method may comprise providing a mold having a suitable cross-sectional shaper and/or contour to provide a wear resistant layer of a desired contour on a metallic substrate (article) disposed in the mold. For example, the mold may provide a wear resistant layer having a screw thread contour on an exterior surface of a metallic substrate having a circular contour.

In various embodiments, infiltrating the hard particles with the metallic binder material may comprise infiltrating at an infiltration temperature. In particular non-limiting embodiments, the infiltrating temperature may be in the range of 700° C. up to 1350° C. For certain non-limiting embodiments of the method, such as non-limiting embodiments in which the binder is aluminum or an aluminum-based alloy, the infiltrating temperature range may be 700° C. to 850° C. For certain non-limiting embodiments of the method in which the binder is copper or a copper-based alloy, the infiltrating temperature range may be 1000° C. to 1250° C. For certain non-limiting embodiments of the method in which the binder is nickel or a nickel-based alloy and includes minor levels of boron, silicon, and/or chromium, the infiltrating temperature range may be 1200° C. to 1400° C. The metallic substrate (article) and/or the metallic binder material may be held at the infiltrating temperature in order to melt the metallic binder material and allow it to infiltrate pores intermediate the hard particles. In certain non-limiting embodiments, for example, the infiltration temperature may be 50° C. to 100° C. greater than the liquidus temperature of the metallic binder material. In certain embodiments of the method, the hard particles may have a solidus temperature at least 50° C. greater than a liquidus temperature of the metallic binder material. Also, in certain embodiments of the method, the metallic binder material may have a liquidus temperature at least 200° C. greater than a liquidus temperature of the metallic substrate. The melting temperature of the hard particles may be greater than a melting temperature of the metallic binder material. In certain non-limiting embodiments, the substrate material has a solidus temperature ranging from 1350° C. to 1600° C. depending upon the particular alloy system involved (for example, steels, titanium, nickel, or cobalt-based alloys). In certain non-limiting embodiments, the melting temperature of the hard particles ranges from 1600° C. to 3500° C., depending upon the composition of the hard particles. For example, tungsten carbide-based hard particles may have a melting temperature in the range of 2800° C. to 3500° C. range, while aluminum oxide and silicon carbide hard particles may have a melting temperature in the range of 1800° C. to 2500° C. The method may comprise heating the metallic substrate at a temperature greater than the melting temperature of the metallic binder material and less than the melting temperature of the hard particles for less than one hour. In certain other embodiments of the method, the method may comprise heating the metallic substrate at a temperature greater than the melting temperature of the metallic binder material and less than the melting temperature of the hard particles for one hour or more.

In various embodiments, infiltrating the hard particles with the metallic binder material comprises dispersing the hard particles in the metallic binder material. Dispersing the hard particles in the metallic binder material may comprise melting a homogeneous layer of the metallic binder material and flowing molten metallic binder material into pores intermediate the hard particles. For example, when the homogeneous layer of the metallic binder material illustrated in FIG. 2 is heated to an infiltration temperature (which is at least as high as the liquidus temperature of the metallic binder material), the molten metallic binder material may flow under gravity into pores intermediate the hard particles. In various embodiments, dispersing the hard particles in the metallic binder material may comprise melting the metallic binder material in a heterogeneous layer of the hard particles and metallic binder material, and flowing molten metallic binder material into pores intermediate the hard particles. In various embodiments, infiltrating the hard particles with the metallic binder material may comprise wetting the hard particles with the metallic binder material.

In various non-limiting embodiments, the method may comprise, after infiltrating the metallic substrate with the metallic binder material, cooling the wear resistant layer. Relatively small articles may be placed in an insulated chamber to slow cooling and inhibit thermal cracking. Larger articles may be allowed to cool at room temperature, without or without assisted cooling. Those having ordinary skill will be able to determine a suitable cooling regimen for a particular article and wear resistant layer.

In various non-limiting embodiments, the method may comprise, after infiltrating the hard particles with the metallic binder material, removing the mandrel and/or funnel by at least one of turning, milling, drilling, and electrical discharge machining. In various embodiments, the infiltration temperature may be greater than a decomposition temperature of the mandrel. For example, infiltrating the hard particles with the metallic binder material may vaporize the mandrel. In various embodiments, the method may comprise separating one of the funnel and mold from the metallic substrate. The article may be inspected and, if desired, may be further processed as needed to remove any oxide scale and/or provide a desired surface finish on the wear resistant layer.

### EXAMPLES

The various embodiments described herein may be better understood when read in conjunction with the following representative examples, which are provided for purposes of illustration only and not as a limitation on the scope of the present disclosure or the attached claims.

### Example 1

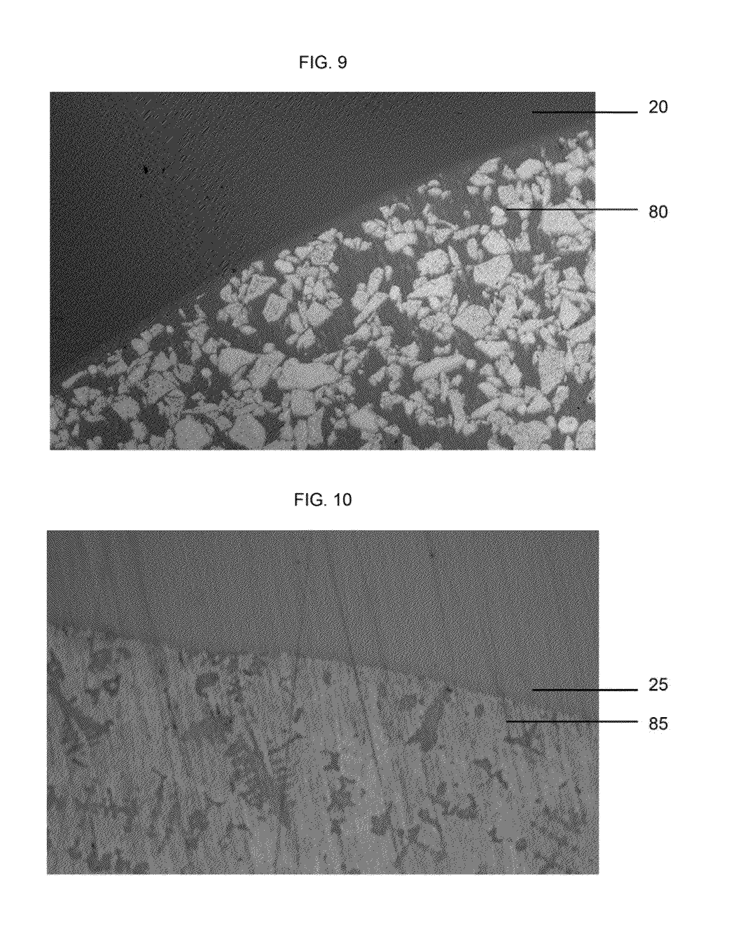

FIG. 9 is a photograph illustrating a stainless steel (Type 304) tube comprising a wear resistant layer on the interior surface of the stainless steel tube formed by an embodiment of a method according to the present disclosure. A mandrel comprising a cylindrical plug was machined from graphite. The outside diameter of the plug was about 12.7 mm smaller than the inside diameter of the stainless steel tube. The length of the plug was approximately the same length as the stainless steel tube. The plug was placed in the stainless steel tube and hard particles in the form of cast tungsten carbide powder (WC+W₂C) were disposed in the gap between the graphite plug and the stainless steel tube. A graphite funnel was placed on top of the assembly. Pellets of a metallic binder material comprising bronze (in weight percentages, 78% copper, 10% nickel, 6% manganese, and 6% tin) were placed in the funnel. The liquidus temperature of the bronze binder material is about 1050° C. The general arrangement of the assembly of the plug, stainless steel tube, hard particles, funnel, and metallic binder material is illustrated schematically in cross-section in FIG. 2. The assembly may be positioned in a preheated furnace (including an air atmosphere) at a temperature in the 1100° C. to 1200° C. range. In the example, the assembly was positioned in the preheated furnace at a temperature of about 1180° C. for about 40 minutes. The temperature inside the furnace exceeded the liquidus temperature of the bronze, but was less than the solidus temperature of the tungsten carbide particles, which is greater than 3000° C. The bronze pellets melted and infiltrated the pores intermediate the particles of the cast tungsten carbide powder. The stainless steel tube (now including a wear resistant layer of tungsten carbide particles dispersed in a bronze binder matrix) and the mandrel were cooled to about room temperature and cleaned by machining and/or shot blasting. The mandrel was broken or machined away, and excess material was removed by grinding. FIG. 9 illustrates the microstructure of the metallurgical bond region between the stainless steel tube 20 and the wear resistant layer 80. As shown in FIG. 9, the tungsten carbide-bronze wear resistant layer 80, which comprised tungsten carbide (light phase in region 80) in a bronze binder (dark phase in region 80), was metallurgically bonded to the interior surface of the stainless steel tube 20.

### Example 2

FIG. 10 is a photograph illustrating a stainless steel (Type 304) tube comprising a wear resistant layer on the interior surface of the stainless steel tube formed by an embodiment of a method according to the present disclosure. A mandrel comprising a cylindrical plug was machined from graphite. The outside diameter of the plug was about 12.7 mm smaller than the inside diameter of the stainless steel tube. The length of the plug was approximately the same length as the stainless steel tube. The plug was placed in the stainless steel tube and hard particles in the form of silicon carbide particles having an average particle size of about 250 μm were disposed in the gap between the graphite plug and the stainless steel tube. A graphite funnel was placed on top of the assembly. Pellets of a metallic binder material comprising bronze (in weight percentages, 78% copper, 10% nickel, 6% manganese, and 6% tin) were placed in the funnel. The general arrangement of the assembly of the plug, stainless steel tube, hard particles, funnel, and metallic binder material is illustrated schematically in cross-section in FIG. 2. The assembly was positioned in a preheated furnace (air atmosphere) at a temperature of about 1180° C. for about 40 minutes. The temperature inside the furnace exceeded the liquidus temperature of the bronze. The bronze pellets melted and infiltrated the pores intermediate the particles of silicon carbide. The stainless steel tube (now including a wear resistant layer of silicon carbide particles dispersed in a bronze binder matrix) and the mandrel were cooled to about room temperature and cleaned by machining and/or shot blasting. The mandrel was broken or machined away, and excess material was removed by grinding. FIG. 10 illustrates the microstructure of the metallurgical bond region between the stainless steel tube 25 and the wear resistant layer 85. As shown in FIG. 10, the wear resistant layer 85, which comprised silicon carbide (dark phase in region 85) in a bronze binder (lighter phase in region 85), was metallurgically bonded to the interior surface of the stainless steel tube 25.

### Example 3

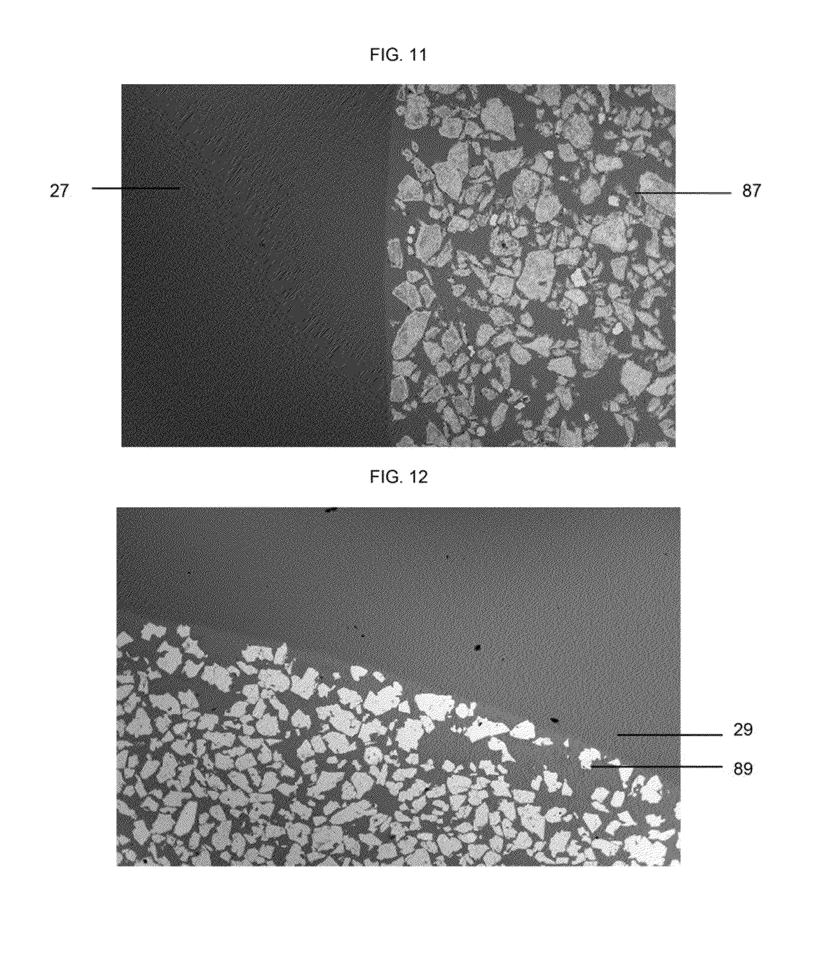

FIG. 11 is a photograph illustrating a stainless steel (Type 304) tube comprising a wear resistant layer on the interior surface of the stainless steel tube formed by an embodiment of a method according to the present disclosure. A mandrel comprising a cylindrical plug was machined from graphite. The outside diameter of the plug was about 12.7 mm smaller than the inside diameter of the stainless steel tube. The length of the plug was approximately the same length as the stainless steel tube. The plug was placed in the stainless steel tube and hard particles in the form of cast tungsten carbide powder (WC+W₂C) were placed in the gap between the graphite plug and the stainless steel tube. A graphite funnel was placed on top of the assembly. Pellets of a metallic binder material comprising brass were placed in the funnel. The assembly was positioned in a preheated furnace (air atmosphere) at a temperature of about 1160° C. for about 40 minutes. The temperature inside the furnace exceeded the liquidus temperature of the brass. The brass pellets melted and infiltrated the pores intermediate the particles of tungsten carbide. The stainless steel tube (now including a wear resistant layer of tungsten carbide particles dispersed in a brass binder matrix) and the mandrel were cooled to about room temperature and cleaned by machining and/or shot blasting. The mandrel was broken or machined away, and excess material was removed by grinding. FIG. 11 illustrates the microstructure of the metallurgical bond region between the stainless steel tube 27 and the wear resistant layer 87. As shown in FIG. 11, the wear resistant layer 87, which comprised tungsten carbide (light phase in region 87) in a brass binder (dark phase in region 87), was metallurgically bonded to the interior surface of the stainless steel tube 27.

### Example 4

FIG. 12 is a photograph illustrating a stainless steel (Type 304) tube comprising a wear resistant layer on the interior surface of the stainless steel tube formed by an embodiment of the method according to the present disclosure. A mandrel comprising a cylindrical plug was machined from graphite. The outside diameter of the plug was about 12.7 mm smaller than the inside diameter of the stainless steel tube. The length of the plug was approximately the same length as the length of the stainless steel tube. The plug was placed in the stainless steel tube and hard particles in the form of monocrystalline tungsten carbide powder were placed in the gap between the graphite plug and the stainless steel tube. A graphite funnel was placed on top of the assembly. Pellets of a metallic binder material comprising brass ((in weight percentages, 53% copper, 15% nickel, 24% manganese, and 8% zinc) were placed in the funnel. The general arrangement of the assembly of the plug, stainless steel tube, hard particles, funnel, and metallic binder material is illustrated schematically in cross-section in FIG. 2. The assembly was positioned in a preheated furnace (air atmosphere) at a temperature of 1160° C. for 40 minutes. The temperature inside the furnace exceeded the liquidus temperature of the brass. The brass pellets melted and infiltrated the pores intermediate the particles of tungsten carbide. The stainless steel tube (now including a wear resistant layer of tungsten carbide particles dispersed in a brass binder matrix) and the mandrel were cooled to about room temperature and cleaned by machining and/or shot blasting. The mandrel was broken ormachined away, and excess material was removed by grinding. FIG. 12 illustrates the microstructure of the metallurgical bond region between the stainless steel tube 29 and the wear resistant layer 89. As shown in FIG. 12, the wear resistant layer 89, which comprised tungsten carbide (light phase in region 89) in a brass binder (dark phase in region 89), was metallurgically bonded to the interior surface of the stainless steel tube 29.

All documents cited herein are incorporated herein by reference, but only to the extent that the incorporated material does not conflict with existing definitions, statements, or other documents set forth herein. To the extent that any meaning or definition of a term in this document conflicts with any meaning or definition of the same term in a document incorporated by reference, the meaning or definition assigned to that term in this document shall govern. The citation of any document is not to be construed as an admission that it is prior art.

While particular embodiments have been illustrated and described herein, it those skilled in the art will understand that various other changes and modifications can be made without departing from the spirit and scope of the invention. Those skilled in the art will recognize, or be able to ascertain using no more than routine experimentation, numerous equivalents to the specific methods described herein, including alternatives, variants, additions, deletions, modifications and substitutions. This disclosure, including the appended claims, is intended to cover all such equivalents that are within the spirit and scope of this invention.

1. A method of forming a wear resistant layer on at least a region of a surface of a metallic substrate, the method comprising:
positioning a mandrel proximate to the surface of the metallic substrate to define a gap between the mandrel and the surface of the metallic substrate;
positioning hard particles in the gap adjacent the metallic substrate; and
infiltrating the hard particles with a metallic binder material, thereby binding together the hard particles to form the wear resistant layer metallurgically bonded to the surface.

2. The method of claim 1, wherein the metallic substrate comprises one of a steel, nickel, a nickel alloy, titanium, a titanium alloy, aluminum, an aluminum alloy, copper, a copper alloy, cobalt, and a cobalt alloy.

3. The method of claim 1, wherein the metallic binder material comprises at least one of copper, a copper alloy, aluminum, an aluminum alloy, iron, an iron alloy, nickel, a nickel alloy, cobalt, a cobalt alloy, titanium, a titanium alloy, magnesium, a magnesium alloy, a bronze, and a brass.

4. The method of claim 1, wherein the metallic binder material comprises a bronze consisting essentially of 78 weight percent copper, 10 weight percent nickel, 6 weight percent manganese, 6 weight percent tin, and incidental impurities.

5. The method of claim 1, wherein the metallic binder material comprises a bronze consisting essentially of 53 weight percent copper, 24 weight percent manganese, 15 weight percent nickel, 8 weight percent zinc, and incidental impurities.

6. The method of claim 1, wherein the metallic binder material further comprises at least one melting point reducing constituent selected from the group consisting of boron, a boride, silicon, a silicide, chromium, and manganese.

7. The method of claim 1, wherein the hard particles comprise at least one of carbide particles, nitride particles, boride particles, silicide particles, oxide particles, and particles comprising a solid solution of at least two of carbide, nitride, boride, silicide, and oxide.

8. The method of claim 7, wherein the hard particles comprise carbide particles of at least one transition metal selected from titanium, chromium, vanadium, zirconium, hafnium, tantalum, molybdenum, niobium, and tungsten.

9. The method of claim 1, wherein the hard particles comprise sintered cemented carbide particles including at least one carbide of a metal selected from Groups IVB, VB, and VIB of the Periodic Table dispersed in a continuous binder comprising at least one of cobalt, a cobalt alloy, nickel, a nickel alloy, iron, and an iron alloy.

10. The method of claim 9, wherein the sintered cemented carbide particles comprise:
60 to 98 weight percent of at least one carbide of a metal selected from Groups IVB, VB, and VIB of the Periodic Table; and
2 to 40 weight percent of the continuous binder.

11. The method of claim 9, wherein the continuous binder of the sintered cemented carbide particles further comprises at least one additive selected from tungsten, chromium, titanium, vanadium, niobium, and carbon in a concentration up to the solubility limit of the additive in the continuous binder.

12. The method of claim 9, wherein the continuous binder of the sintered cemented carbide particles further comprises at least one additive selected from silicon, boron, aluminum, copper, ruthenium, and manganese.

13. The method of claim 1, wherein the hard particles comprise at least one of a metal powder and a metal alloy powder.

14. The method of claim 1, wherein the hard particles have an average particle size of 1 to 200 micrometers.

15. The method of claim 1, wherein a melting temperature of the hard particles is greater than a melting temperature of the metallic binder material.

16. The method of claim 15, further comprising:
heating the metallic substrate at a temperature greater than the melting temperature of the metallic binder material and less than the melting temperature of the hard particles for less than one hour.

17. The method of claim 1, wherein the hard particles have a solidus temperature at least 50° C. greater than a liquidus temperature of the metallic binder material.

18. The method of claim 1, wherein the metallic binder material has a liquidus temperature at least 200° C. greater than a liquidus temperature of the metallic substrate.

19. The method of claim 1, wherein infiltrating the hard particles with the metallic binder material comprises infiltrating at a temperature 50° C. to 100° C. greater than the liquidus temperature of the metallic binder material.

20. The method of claim 1, wherein infiltrating the hard particles with the metallic binder material comprises melting a homogeneous layer of the metallic binder material and flowing molten metallic binder material into pores intermediate the hard particles.

21. The method of claim 1, wherein the wear resistant layer comprises at least 75 volume percent of the hard particles.

22. The method of claim 1, wherein the wear resistant layer comprises 25 to 75 volume percent of the hard particles.

23. The method of claim 1, wherein the wear resistant layer comprises 10 to 90 volume percent of the hard particles.

24. The method of claim 1, wherein a thickness of the wear resistant layer is from 1 mm to 250 mm.

25. The method of claim 1, wherein a thickness of the wear resistant layer is greater than 25 mm.

26. The method of claim 1, wherein a cross-sectional shape of the wear resistant layer is one of a circle, an ellipse, a parallelogram, a rectangle, a square, a trapezoid, a triangle, and combinations thereof.

27. The method of claim 1, wherein the wear resistant layer comprises a first cross-sectional shape in a first region and a second cross-sectional shape in a second region.

28. The method of claim 1, wherein a cross-sectional shape of the wear resistant layer differs from a cross-sectional shape of the metallic substrate.

29. The method of claim 1, wherein a contour of the wear resistant layer differs from a contour of the metallic substrate.

30. (canceled)

31. The method of claim 1, wherein the gap is less than 25.4 mm.

32. The method of claim 1, wherein positioning the hard particles adjacent the metallic substrate comprises positioning a homogeneous layer of the hard particles in the gap.

33. The method of claim 1, further comprising:
positioning a homogeneous layer of the metallic binder material adjacent the homogeneous layer of the hard particles and adjacent the mandrel.

34. The method of claim 1, further comprising, after infiltrating the hard particles with the metallic binder material:
removing the mandrel by at least one of turning, milling, drilling, and electrical discharge machining.

35. The method of claim 1, wherein a cross-sectional shape of the mandrel comprises one of a circle, an ellipse, a parallelogram, a rectangle, a square, a trapezoid, a triangle, and combinations thereof.

36. The method of claim 1, further comprising, after infiltrating the metallic substrate with the metallic binder material:
cooling the wear resistant layer.

37. The method of claim 1, further comprising forming an article of manufacture comprising the substrate and the wear resistant layer.

38. The method of claim 37, wherein the article of manufacture is one of a pipe, a tube, a valve, a valve part, a flange, a bearing, a drill bit, an earth boring bit, a die, and a container.

39. The method of claim 37, wherein the article of manufacture comprises wear surfaces of parts and components used in earth moving equipment.

40. The method of claim 1, with the proviso that the wear resistant layer is not formed by any of welding and hardfacing.

41. The method of claim 1, wherein the wear resistant layer is metallurgically bonded to at least one of an interior surface of the metallic substrate and an exterior surface of the metallic substrate.

42. The method of claim 1, further comprising, prior to positioning the hard particles adjacent the metallic substrate:
positioning the metallic substrate in a mold to define a gap between the mold and the metallic substrate.

43. The method of claim 42, wherein the gap is less than 25.4 mm.

44. The method of claim 42, further comprising:
positioning a homogeneous layer of the metallic binder material adjacent a homogeneous layer of the hard particles in the mold.

45. The method of claim 42, wherein a cross-sectional dimension of the mold comprises one of a circle, an ellipse, a parallelogram, a rectangle, a square, a trapezoid, a triangle, and combinations thereof.

46. A method of forming a wear resistant layer on at least a region of a surface of a metallic substrate comprising one of a steel, nickel, a nickel alloy, titanium, a titanium alloy, aluminum, an aluminum alloy, copper, a copper alloy, cobalt, and a cobalt alloy, the method comprising:
positioning a mandrel proximate to the surface of the metallic substrate to define a gap between the mandrel and the surface of the metallic substrate;
positioning hard particles comprising at least one of carbide particles, nitride particles, boride particles, silicide particles, oxide particles, and particles comprising a solid solution of at least two of carbide, nitride, boride, silicide, and oxide in the gap adjacent the metallic substrate; and
infiltrating the hard particles with a metallic binder material comprising at least one of copper, a copper alloy, aluminum, an aluminum alloy, iron, an iron alloy, nickel, a nickel alloy, cobalt, a cobalt alloy, titanium, a titanium alloy, magnesium, a magnesium alloy, a bronze, and a brass, thereby binding together the hard particles to form the wear resistant layer metallurgically bonded to the surface.

47. (canceled)

48. The method of claim 46, wherein positioning the hard particles adjacent the metallic substrate comprises positioning a homogeneous layer of the hard particles in the gap.

49. The method of claim 48, further comprising, after infiltrating the hard particles with the metallic binder material:
removing the mandrel by at least one of turning, milling, drilling, and electrical discharge machining.

50. The method of claim 49, further comprising, after infiltrating the metallic substrate with the metallic binder material:
cooling the wear resistant layer.
